(19) United States
(12) Patent Application Publication
(10) Pub. No.: US 2009/0138332 A1
(43) Pub. Date: May 28, 2009

(54) SYSTEM AND METHOD FOR DYNAMICALLY ADAPTING A USER SLIDE SHOW PRESENTATION TO AUDIENCE BEHAVIOR

(76) Inventors: Dimitri Kanevsky, Ossining, NY (US); Wilfredo Ferre, Le Mesnil le Roi (FR)

Correspondence Address: HOFFMAN WARNICK LLC, 75 STATE ST, 14 FL, ALBANY, NY, 12207, US

(21) Appl. No.: 12/256,759

(22) Filed: Oct. 23, 2008

(30) Foreign Application Priority Data
Nov. 23, 2007 (EP) 07301573.7

(51) Int. Cl. G06Q 90/00; G06F 3/048

(52) U.S. Cl. 705/10; 715/730

(57) ABSTRACT

The invention is directed to a system and method for dynamically adapting a computer implemented user presentation to an audience behavior reaction. The system senses biometrics information in real-time, compares it to a reference audience behavior, and adjusts the show accordingly by modifying parameters of the presentation.

### TECHNICAL FIELD

The present invention relates in general to the field of presentations, and more particularly, to a system and method for adapting a computer displayed presentation according to audience behavior feedback.

### BACKGROUND OF THE INVENTION

Regardless of the format, presentations have an obligation “first and foremost” to their audience. They have to be presented in a timely but also in an engaging and lively manner.

The major issue of presentations is to stimulate the interest-target of the audience. The challenge is to offer media and other features as elements for further consideration of the audience being targeted. This resides in presenting elements in a format that is tailored to the targeted audiences whatever their interest/engagement and circumstances. Commentators, speakers, presenters or users handle these elements to the presentation to make it look attractive to audience that wants entertainment, enlightenment and education.

For the sake of simplicity, the designation of commentator, speaker, presenter and any other persons who can initiate a presentation to an audience will be known henceforth as “user” all along the invention description.

When a presentation in ongoing, a user has to continually ensure that his/her presentation gives the expected insight to the targeted audience to maintain its interest/engagement. Gauging, on the fly, the interest level of an audience and/or determining how to pique its interest leave some concerns to the user.

There exist a number of situations where a presentation needs adjusting or changing quickly to reflect the targeted audience. For example, a user finds out a few minutes before the presentation starts that the expected audience of adults will be mostly children. It is therefore important to adapt the content of the presentation so children can understand it and find it interesting.

It is even more difficult for a user to readjust an ongoing presentation, to make it more attractive when a part of the audience starts losing interest. For example, if the audience is falling asleep, talking and/or seems confused.

Another concern resides when a user has to readjust the content of a presentation beforehand or just before starting the presentation in order to satisfy new schedule requirements. It is also possible for a user to adapt the ongoing presentation with a targeted audience by reducing the content, by swapping and/or removing inadequate slides. Such adjustments often lead to a sloppy presentation.

It is also desirable to assure substantial time for interaction between user and audience and/or get ample time for discussion with the audience instead of using a short time-minute presentation that was allotted by organizers.

Due to a lack of flexibility, existing methods do not allow a user to readjust a presentation dynamically. Indeed, the existing methods do not consider the homogeneity of the audience, the interesting level of the audience and the environmental context in real time. Moreover, they do not allow a user to make adjustment easier that does not facilitate congenial exchange between audience and user. Some adjustments that overcome a punctual concern do not take care of the entire content of the presentation as well as of its major objectives. Readjusting a presentation this way, can make the content incompatible with the original presentation objectives that were previously determined to satisfy the targeted audience.

There exist a number of “live editing” tools to enhance a user's presentation. Most of them consist in integrating audio and video to maximize the presentation's impact. Other features consist in adding animated and static effects on slide transition to make the presentation more attractive. Another possibility consists in merging media to a power point support to make an audience more captivated by the content of the presentation.

Some of these tools provide excellent viewing capabilities for various document formats, but they do not take the feedback of the audience into account and do no readjust the ongoing presentation accordingly. Thereby, there is no change in the presentation original content and the lack of audience's feedback feature decreases considerably the exchange between audience and user.

Other means allow the audience to focus on the presentation, like handling audio and visual effects outside of the presentation. For example, the user can change the lighting of the room, increase or decrease the volume, all similar techniques which can make the presentation more engaging.

To summarize, the aforementioned tools and methods present several drawbacks. Existing tools and methods are too rigid and do not allow a user to readjust a presentation dynamically. Existing tools and methods do not consider the homogeneity of the audience, the interesting level of the audience and the environmental context in real time. Existing tools and methods do not allow a user to make adequate adjustment on the fly by taking care of the audience's feedback which then does not facilitate congenial exchange between audience and user. Existing tools and methods overcome a punctual concern with no care of the entire content of the presentation as well as of its major objectives. Overcoming a punctual concern like this can create major deviations on the original presentation objectives that were previously determined to satisfy the targeted audience.

As mentioned above, prior art solutions are not fully appropriated to adjust an ongoing user's presentation by using audience's feedback capabilities in real time. The existing tools and methods present various drawbacks when a presentation needs to be adjusting on the fly to the audience in case of paramount necessity and/or emergency. Particularly, this case occurs when the audience differs from the one that it was expected. The existing tools and methods are too rigid and are really user dependent. Changes and/or modifications have to be inserted before the presentation starts and there is no possibility to readjust the ongoing presentation by merging corrective content from another database dynamically. Furthermore, the existing tools and methods do not consider the motivation index of the audience as well as the homogeneity of the audience and the environmental context to provide the audience with the adequate attractiveness on the matter.

### SUMMARY OF THE INVENTION

The present invention provides a system and method for monitoring a presentation based on biometrics capabilities. The present invention provides a self-regulated mechanism to adjust a user's presentation in accordance with the biometry of an audience and the user's expectation. Further, present invention detects the deviations between the audience engagement/interest and an ongoing user's presentation in order to determine the adequate user's presentation adjustments accordingly. The present invention uses a biometrics audience feedback-loop mechanism to control dynamically the arrangement of an ongoing user's presentation.

The present invention is configured to adapt an ongoing presentation with a targeted audience in real time by using biometrics sensors. The present invention interprets the biometry information related to an audience using a knowledge-based system.

The present invention provides a live user's presentation with a self-monitoring system and method based on historical presentation's situation. Further, the present invention inserts appropriate attractiveness on a user's presentation to make the ongoing presentation more attractive.

The present invention integrates a scheduling mechanism to manage the allotted time of the ongoing user's presentation as well as the substantial time for questions and discussion from the floor while maintaining the important information of the presentation. In addition, the present invention uses a sophisticated biometry acquisition system by mixing both speech and behavior recognition mechanisms.

An aspect of the present invention provides a system for monitoring a computer implemented presentation in accordance to an audience reaction, comprising: storing means for storing a set of predefined audience behavior parameters to define a reference audience behavior; sensing means for sensing biometrics information indicative of an ongoing audience behavior; means for processing the sensed biometrics information to detect an audience behavior deviation compared to the reference audience behavior; and means for generating one or more presentation adjustments parameters in case of deviation.

Another aspect of the present invention provides a method for monitoring a computer implemented presentation in accordance to an audience reaction, comprising: storing a set of predefined audience behavior parameters to define a reference audience behavior; receiving biometrics information indicative of an ongoing audience behavior; processing the biometrics information to detect an audience behavior deviation compared to the reference audience behavior; and generating one or more presentation adjustments parameters in case of deviation.

Further aspects of the invention will now be described, by way of implementation and examples, with reference to the accompanying figures.

### BRIEF DESCRIPTION OF THE DRAWINGS

The above and other items, features and advantages of the invention will be better understood by reading the following more particular description of the invention in conjunction with the accompanying drawings.

FIG. 1 shows a block diagram of an implementation of the present invention.

FIG. 2 depicts in a high level, the functional blocks of the Live Presentation Manager System of the present invention as referenced in FIG. 1.

FIG. 3 illustrates in a high level, an implementation of the Biometrics Information Manager.

FIG. 4 illustrates in a high level, an implementation of a Live Presentation Manager Service.

FIG. 5 is a flow chart of the initialization process.

FIG. 6 is a flow chart of the ongoing process of a presentation.

### DETAILED DESCRIPTION OF THE INVENTION

Embodiments of the invention are described herein by way of examples with reference to the accompanying figures and drawings.

More specifically, according to a first aspect, the present invention consists in monitoring a live presentation in accordance with a targeted audience in real time, herein named Presentation Auto Biometrics Adjustment System (PABAS), and a method allowing an ongoing presentation to be self-readjusted by using biometrics audience feedback capabilities.

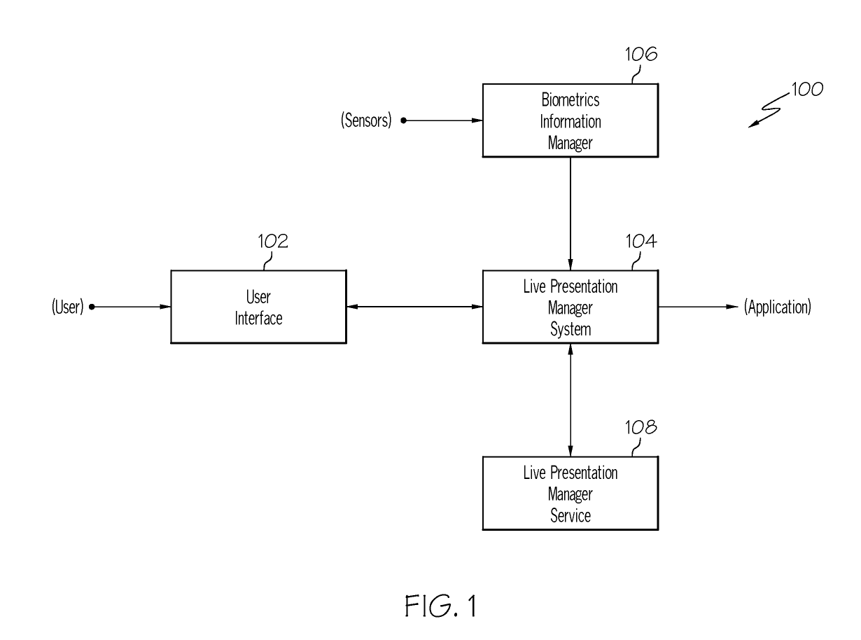

As shown in FIG. 1, a symbolic view of the system of the present invention, named Presentation Auto Biometrics Adjustment System (PABAS), shows a User Interface (102), a Live Presentation Manager System (104), a Biometrics Information Manager (106), and a Live Presentation Manager Service (108).

The User Interface (102) interfaces with both the Live Presentation Manager System (104) and the user (User). The User Interface (102) receives information flux from the Live Presentation Manager System (104) and allows the user to react to the presentation accordingly.

The Live Presentation Manager System (104) interacts with the User Interface (102), the Biometrics Information Manager (106) and the Live Presentation Manager Service (108). It also communicates with an application (Application) that reports or/and displays the progression of the ongoing presentation to the user (not shown here).

The Live Presentation Manager System (104) provides the user with information on the biometry of the audience from the Biometrics Information Manager (106). Moreover, it gives the user a status of the user's presentation adjustments from the Live Presentation Manager Service (108) and it stores the content of a user's presentation with its associated data instructions via the User Interface (102).

The information on the biometry of the audience is collected from different sensors (Sensors) that are located in a conference room or forum or equivalent, such as cameras and microphones or other kinds of biometrics system capture (not described here). These sensors measure the audience enthusiasm and attentiveness to the presentation and transmit related biometrics information to the Biometrics Information Manager (106).

The Biometrics Information Manager (106) communicates the information on the biometry related to the audience to the Live Presentation Manager System (104) that feeds the Live Presentation Manager Service (108) with the context.

The Live Presentation Manager Service (108) is a knowledge-based system that interprets the information on the biometry related to the audience, makes a decision, launches an action and provides the Live Presentation Manager System (104) with the adequate presentation adjustments accordingly. For example, if the biometrics sensors detect that the audience is falling asleep, the Live Presentation Manager Service (108) automatically inserts an adequate attractiveness, like a joke between diagrams and objects in the user's presentation to make the presentation more attractive.

The Live Presentation Manager System (104) receives the content of a user's presentation with its associated data instructions such as content, topic, length, type of media, intended audience, allotted time and other parameters that can characterize a presentation. In addition it gets the presentation adjustments from the Live Presentation Manager Service (108) and transmits them to the user, via the User Interface (102) to be validated for approval. Then, the Live Presentation Manager System (104) inserts the changes into the user's presentation and initiates the application by displaying the fixed presentation to the audience.

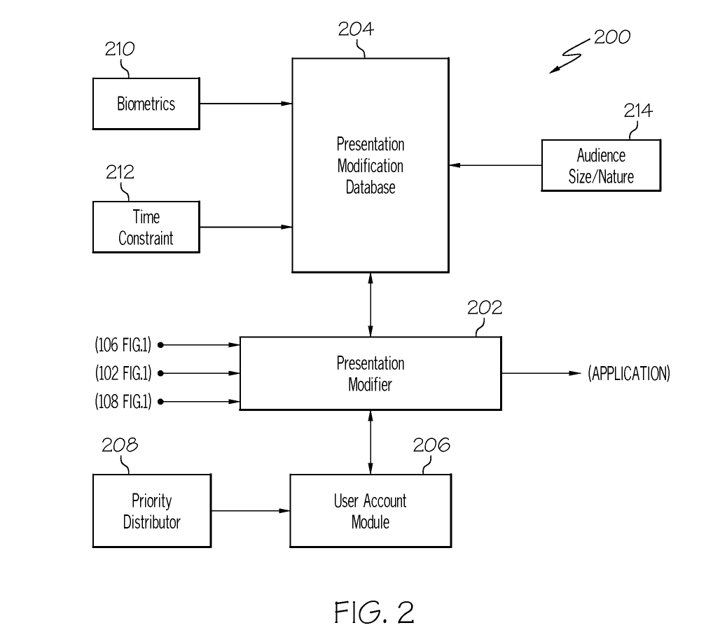

FIG. 2 depicts in a high level, the functional blocks of the Live Presentation Manager System (LPMS) (200) of the present invention. The Live Presentation Manager System (LPMS) (200) provides a self-regulated mechanism to adjust a user's presentation in accordance with both the biometry of the audience and the user's expectation.

The Live Presentation Manager System (200) comprises a Presentation Modifier (202), a Presentation Modification Database (204), a User Account Module (206) and their associated components (208, 210, 212 and 214). In addition, the Live Presentation Manager System (200) contains two embedded reference databases. They store initial data issued from the initialization procedure of the user's presentation. They are respectively located in the User Account Module (206) and the Presentation Modification Database (204).

The Presentation Modifier (202) interacts with the User Interface (102 of FIG. 1), the Live Presentation Manager Service (108 of FIG. 1) and the Biometrics Information Manager (106 of FIG.1). It also communicates with both the Presentation Modification Database (204) and the User Account Module (206).

The Presentation Modifier (202) interprets data gathering, deals with the reference data issued from the initialization procedure, detects audience behavior deviations and generates the adequate changes and/or modifications for a user's presentation with compliance to the biometry context.

In addition, the Presentation Modifier (202) receives and rates the biometry diagnosis on the audience interest from the Biometrics Information Manager (106 of FIG. 1) and compares it with the reference data located into the Presentation Modification Database (204). If the biometrics comparison detects an audience behavior deviation, then the Presentation Modifier (202) initiates the adequate adjustments by using the Live Presentation Manager Service (108 of FIG. 1) capabilities and warns the user.

Moreover, the Presentation Modifier (202) controls the local atmosphere of the venue of the presentation, adjusts lighting and volume settings to help the user capture the audience's attention. For example, if the Biometrics Information Manager warns that the audience is having trouble hearing the speaker (can be determined by measuring confusion from facial expressions and comments such as “I can't hear, or what did he say?” through speech recognition), then the Presentation Modifier adjusts the volume accordingly or prompts the user to pause and fix the problem.

Thereby, the Presentation Modifier detects audience behavior deviations, indexes the audience interest, determines causes and effects, and defines a correct adjustment to be applied to the user's presentation in real time. Then the Presentation Modifier stores all parameters into a Random Access Memory (RAM) or equivalent (not shown here) located in the Presentation Modification Database (204). The data issued from the Biometrics Information Manager periodically updates the storage device, via the Presentation Modifier (202), that makes the Presentation Modification Database (204) in synchronization with the user's presentation modifications. Thus, the Presentation Modification Database stores information on various adjustments allowing the Presentation Modifier to set up the correct actions fitting with the rate of the audience motivation.

The Presentation Modification Database includes three entities: the Biometrics (210), the Time Constraint (212) and the Audience Size/Nature (214).

The Biometrics (210) entity provides different formats for changing the presentation (adding/deleting media) to increase audience attention. It is common during a presentation that not every individual is engaged, but it is not always necessary to change a presentation for one person. However, if the biometrics sensors indicate that a large portion of the audience is falling asleep or losing interest, the Biometrics (210) determines the adequate updates to readjust the user's presentation accordingly.

The Time Constraint (212) entity provides different formats for changing the presentation in the case that the user is running out of time (adding/deleting media, paraphrasing text). The Time Constraint (212) ensures that user's presentations keep to their allotted time as well as allows substantial time for questions and discussion from the floor while maintaining the important information of the presentation.

The Audience Size/Nature (214) entity provides different formats for changing the presentation in case the audience is of a different nature or size than what is expected by the user (adding/deleting media). For example, a group of kids show up to a presentation intended for adults, or only a few persons show up to a presentation intended for a large audience.

The Presentation Modifier (202) also receives data from the User Account Module 206).

The User Account (206) contains user's preferences concerning the presentation maintenance like a preferred selection of the slides that need to be modified against these that will remain locked. In addition, the User Account Module (206) stores environmental data related to the current presentation like topic, length, type of media and intended audience. Both the user's preferences and the environmental data are issued from either the user or the Live Presentation Manager Service (108 of FIG. 1), via the Presentation Modifier (202). The activity of the User Account Module (206) is monitored by a Priority Distributor (208) allowing the Presentation Modifier (202) to change the presentation sequence in a controlled path.

The controlled path consists in managing the presentation sequence in a way that avoids damaging or interfering with the current displayed information.

The Priority Distributor (208) interprets qualifiers related to the sequential ordering importance of data within the presentation. Such qualifiers represent the priority of media, the information that need to be transmitted to the audience and the slides ordering that is presented to the audience.

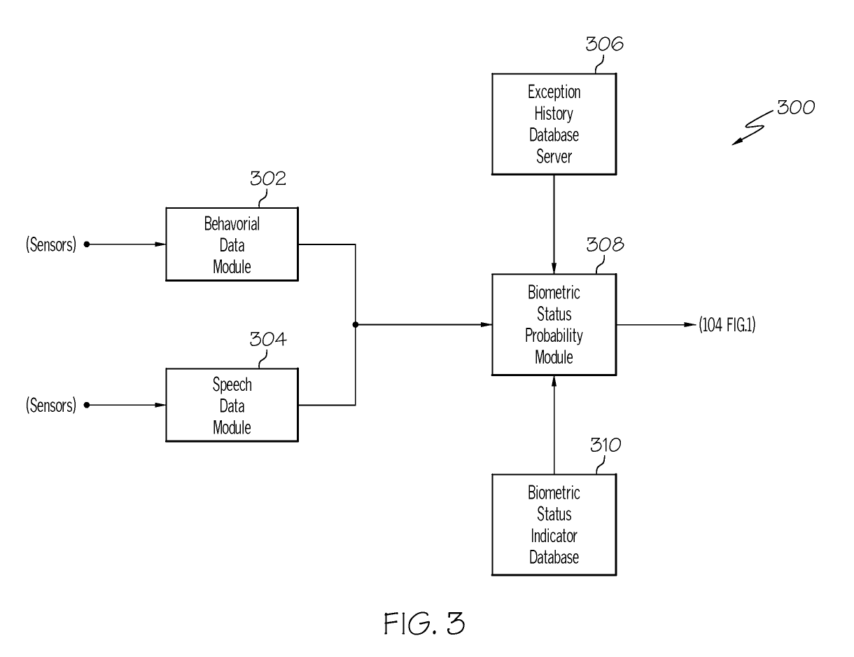

FIG. 3 illustrates in a high level, an implementation of the Biometrics Information Manager (300) as may be applicable to the Presentation Auto Biometrics Adjustment System (PABAS) of the present invention.

The Biometrics Information Manager produces the biometry analysis the Live Presentation Manager System of the present invention needs to operate.

The Biometrics Information Manager contains a Behavior Data Module (302), a Speech Data Module (304), an Exception History Database Server (306), a Biometrics Status Probability Module (308) and a Biometrics Status Indicator Database (310).

The Behavior Data Module (302) and the Speech Data Module (304) receive data from a series of biometrics sensors. The present invention includes a combination of two techniques of biometrics recognition:

a natural biometrics technique that consists in using standard means, such as a computer interface, to sense the audience reactions to the ongoing presentation (i.e., microphone and camera imaging system and, possibly keyboard and mouse); and

a biometrics technique that consists in using sophisticated sensors technology to sense the audience reactions to the ongoing presentation.

When implemented in a biometry concept such sophisticated sensors supplement the natural biometrics technique by observing the audience and acquiring related data that are not currently available with standard measurement (i.e., infrared face temperature, retinal print and so on . . . ).

The Behavior Data Module (302) includes behavior features. The Behavior Data Module analyzes images of human faces for use in facial recognition, heart rate, facial expression, blinking rate and so on, that supplement the acoustic features. In addition, the Behavior Data Module observes and acquires audience gestures and movements by using sophisticated sensors such as a Doppler movement analyzer, video cameras, infrared system, retina scanner or equivalent. The Behavior Data Module measures in real time the movements of the audience as well as the eyes, the eyelid movements and the visual reaction time occurring for each slide transition and records individual characteristics to a database for later acquisition and audience observation procedure.

The Speech Data Module (304) includes acoustic features, such as voice characteristics and answers to random questions. The Speech Data Module recognizes individuals for which voice characteristics are stored in an acoustic database (not shown here). The Speech Data Module queries the individual with a random question to enable the voice recognition process. The Speech Data Module acquires the individual's voice characteristics from the answer to the random question and stores them in the acoustic database for later acquisition and audience observation procedure.

It is to be noted that the answers to the questions do not necessarily have to be spoken. They can be written, drawn, verified or/and mimed (i.e., gestures).

For further information, an example of a speaker recognition system which performs text-independent speaker verification and asks random questions is described in U.S. Pat. No. 5,897,616, titled “Apparatus and Methods for Speaker Verification/Identification/Classifying Employing Non-Acoustic and/or Acoustic Models and Databases”.

Then, both the Behavior Data Module (302) and the Speech Data Module (304) sort the data received, differentiate valuable biometrics signals from insignificant ones and transmit the relevant information to the Biometrics Status Probability Module (308).

As a differentiation example, a person who is sleeping would send a valuable biometrics signal. However, if the presenter asks the audience to close their eyes the system should not assume that the entire audience has fallen asleep.

The Biometrics Status Probability Module (308) receives the biometrics relevant information and samples the audience atmosphere to the running presentation (e.g., audience enthusiasm and attentiveness, audience interest or not, be or falling asleep, and so on) and states a diagnosis in probability terms accordingly.

Results are transmitted to the Live Presentation Manager System (104 of FIG. 1) to initiate the correct action.

Furthermore, the Biometrics Status Probability Module (308) gets information from a Biometrics Status Indicator Database (310) and a “Previous Presentation Scenario” Database Server (306).

The Biometrics Status Indicator Database (310) provides audience parameters containing audience atmosphere characteristics and biometrics data necessary for an audience to achieve a certain state.

For example, the Biometrics Status Indicator Database indexes an audience atmosphere as extremely disinterested if half of the audience has yawned, half of the audience's eyes have not been watching the presenter for the majority of the time, one quarter of the audience is asleep, and another quarter has spoken to the person sitting next to them.

Varying degrees of interest and awareness are referenced into the Biometrics Status Indicator Database (310) based on the biometrics data received.

The Exception History Database Server (306) is a reference database, history-based, where previous information on biometrics data and their meaning are stored. It allows monitoring of the Biometrics Status Probability Module (308) in regards to the history exception when occurs. An exception may be for example: when a presentation is ongoing if everyone stands up it is not because the presentation is over but because the presenter asks the audience to stand for another reason. When occurring, the Scenario History Database Server (306) flags the identified exception and indicates to the Biometrics Status Probability Module (308) to ignore this event.

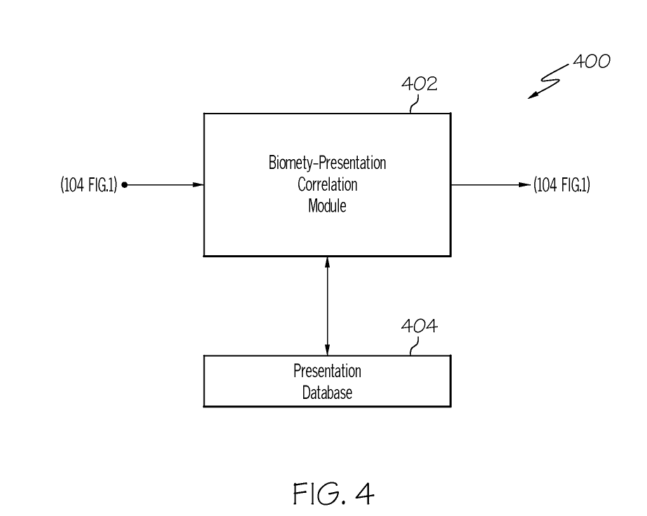

FIG. 4 illustrates in a high level, an implementation of the Live Presentation Manager Service (400) as may be applicable to the Presentation Auto Biometrics Adjustment System (PABAS) of the invention.

The Live Presentation Manager Service includes a Biometry-Presentation Correlation Module (402) associated to a Presentation Database (404). The Biometry-Presentation Correlation Module (402) interprets the biometrics information flushing through the Live Presentation Manager System (104 of FIG. 1).

The Biometry-Presentation Correlation System gets historical data of presentations with its associated data instructions from a database that is located in the Presentation Database (404). The database is stored in a Random Access Memory (RAM) or equivalent support (not shown here). The Biometry-Presentation Correlation System identifies compatible adjustment candidates from the stored data and correlates them with the biometrics information flushing through the Live Presentation Manager System (104 of FIG. 1) of the present context. Then, the Live Presentation Manager Service (400) posts the identified presentation adjustment on the Live Presentation Manager System.

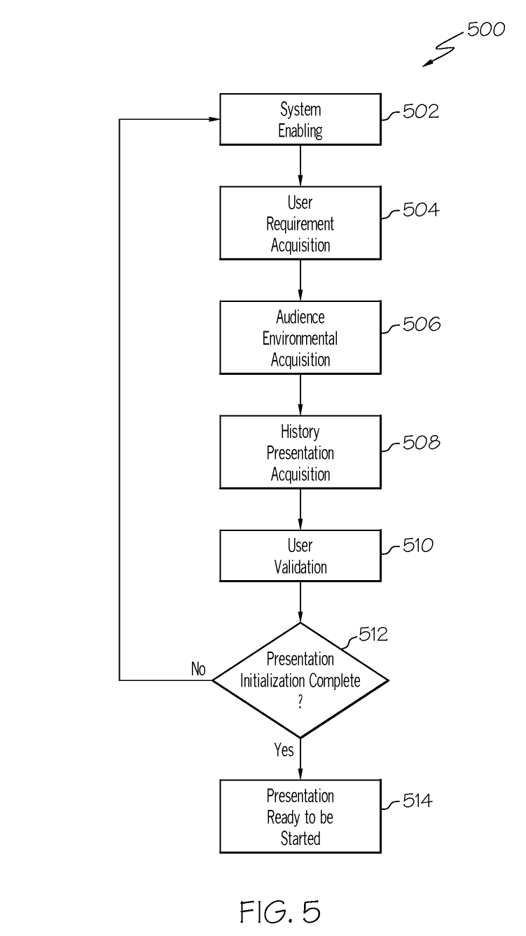

Going now to FIG. 5, a flow chart (500) represents the initialization process of the Presentation Auto Biometrics Adjustment System (PABAS), in an embodiment of the present invention.

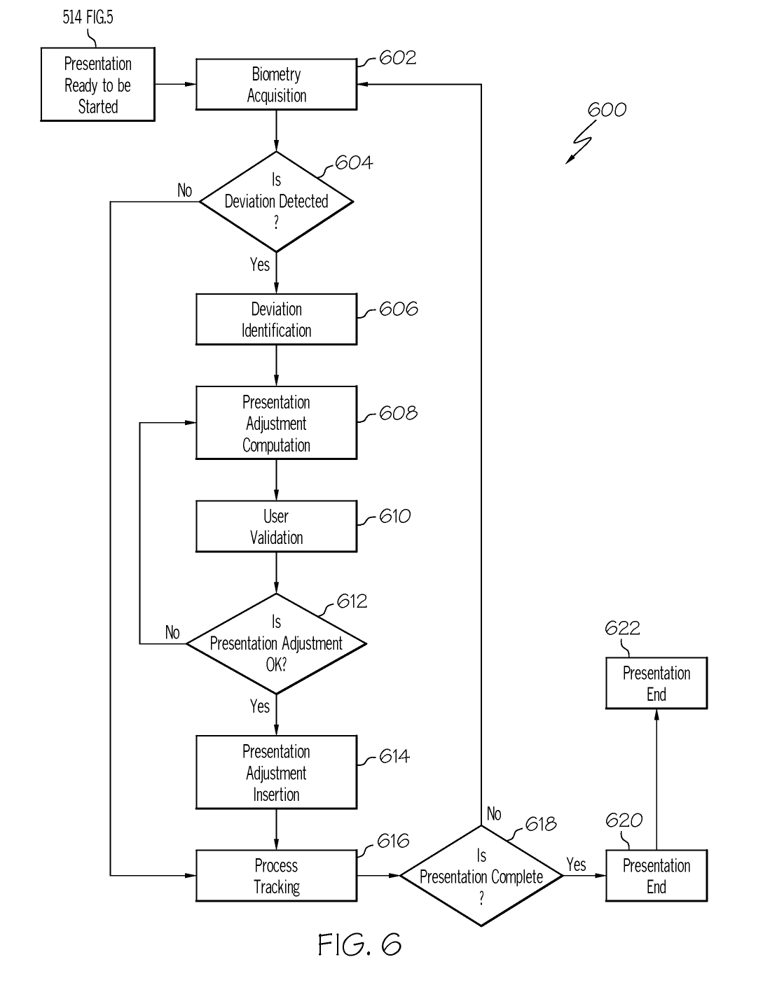

Before the Presentation Auto Biometrics Adjustment System process is started, a preliminary step 502 is performed in which an acquisition of the parameters belonging to the presentation is established. At the end of the initialization process, a self-monitoring process of an ongoing user presentation may be initiated by using audience biometry feedback capabilities as further described with reference to FIG. 6.

Step 502 (System enabling): The user enables the Presentation Auto Biometrics Adjustment System (500) to start the presentation initialization. Then, the process goes to step 504.

Step 504 (User Requirement Acquisition): The user provides the Live Presentation Manager System with user's preferences related to the presentation. The User Account Module (206), that is an embedded partition of the Live Presentation Manager System, receives the presentation user's preferences such as content, topic, length, type of media, intended audience, allotted time and other parameters that can characterize a presentation and stores them to serve as reference. Then, the process goes to step 506.

Step 506 (Audience Environmental Acquisition): The Biometrics Information Manager generates a snapshot of the initial context to serve as reference. Room configuration, meeting attendee identification versus seat location, attendees facial recognition versus seats location and audience nature are stored into the Presentation Modification Database that is an embedded partition of the Live Presentation Manager System. Then, the process goes to step 508.

Step 508 (History Presentation Acquisition): The Live Presentation Manager System connects to the Biometry-Presentation Correlation System that is an embedded partition of the Live Presentation Manager Service. The Biometry-Presentation Correlation System selects from the Presentation Database a historical configuration that best reflects the initial setting of the user's presentation to serve as reference. Then, the process goes to step 510.

Step 510 (User Validation): The user validates the three steps of acquisition related to the user preferences (502), the original audience environment (504) and the selected presentation based on history (506). Then, the process goes to step 512.

Step 512 (Presentation Initialization Complete): A status determines the sequence completion of the initialization process. If the sequence is achieved the process goes to step 514 otherwise the process goes to step 502 that starts the initialization process again.

Step 514 (Presentation is ready to be started): The presentation initialization process is complete. Then the process goes to step 602 of FIG. 6.

Referring now to FIG. 6, a flow chart presents the ongoing process 600 of the Presentation Auto Biometrics Adjustment System, in accordance with an embodiment. As already explained, before the ongoing process starts, the initialization process is performed as described in FIG. 5 to set the user requirements, the initial audience environment and an identified historical presentation configuration to serve as background reference for the ongoing process. Once the initialization process completion is established, the ongoing process starts on step 602.

Step 602 (Biometry Acquisition): the audience biometry acquisition starts. The Biometrics Information Manager (106 of FIG. 1) catches, sorts and evaluates information on the biometry related to the audience. It samples and indexes the audience atmosphere to the ongoing presentation, checks occurrence of history exception and states a biometry diagnosis in probability terms. It transmits the results to the Live Presentation Manager System. Then the process goes to step 604.

Step 604 (Is Deviation Detected): The Presentation Modifier receives and rates the biometry diagnosis on the audience interest from the Biometrics Information Manager. Then, the Presentation Modifier interprets data gathering and initiates a biometrics comparison with the data stored in both the User Account Module and the Presentation Modification Database. The biometrics comparison allows the Presentation Modifier to detect an audience behavior deviation from the data stored into the reference databases. If the Presentation Modifier detects a deviation, then the process goes to step 606 (branch yes of comparator 604) for identification otherwise the process is continually tracked at step 616 (branch no of the comparator 604).

Step 606 (Deviation Identification): The Presentation Modifier connects to the Presentation Modification Database for identification of the detected audience behavior deviation. The Presentation Modifier makes a determination whether the detected audience behavior deviation identification corresponds to the Biometrics entity, the Time Constraint entity or the Audience Size/Nature entity (respectively 210, 212, 214). Once the audience behavior deviation identified, the process goes to step 608.

Step 608 (Presentation Adjustment Computation): The Biometry-Presentation Correlation System that is an embedded partition of the Live Presentation Manager Service receives the identification of the audience behavior deviation. The Biometry-Presentation Correlation System correlates the biometrics information with the data stored into the Presentation Database and identifies compatible adjustment candidates. Then the process goes to step 610.

Step 610 (User Validation): The Live Presentation Manager System receives the identified adjustment candidate to be validated by the user. The Live Presentation Manager System prompts the user via the User Interface. Then the process goes to step 612.

Step 612 (Is Presentation Adjustment OK): The user, via the User Interface, accepts or rejects the identified adjustment candidate issued from the Live Presentation Manager Service. If the user accepts the identified adjustment as a good candidate, the process goes to step 614 (branch Yes of the comparator 612) otherwise the process returns to step 608 (branch No of the comparator 612). Going to step 608, the presentation adjustment computation is initiated again.

Step 614 (Presentation Adjustment insertion): The Live Presentation Manager Service inserts the identified adjustment candidates to the ongoing user's presentation in real time and updates the Presentation Database (404), the Presentation Modification Database (204) and User Account Module (206) accordingly. Then the process goes to step 616.

Step 616 (Process tracking): The entire process is tracked allowing detection of any audience behavior deviation. Then the process goes to step 618.

Step 618 (Is presentation Complete): A status determines the completion of the ongoing user's presentation. Specific information is stored into the User Account Module that determines the completion phase of the ongoing user's presentation. Based on this information, the Presentation Modifier stops the tracking process (branch Yes of the comparator 618) and the process goes to step 620, otherwise the Presentation Modifier continues acquiring the biometry of the audience (branch No of the comparator 618) and the process loops back to step 602.

Step 620 (Presentation End): Presentation Modifier prompts the user about presentation completion. Then the process goes to step 622.

Step 622 (Presentation Saving): The Presentation Modifiers archives all necessary parameters related to the user's presentation to the Presentation Database (404), the Presentation Modification Database (204) and User Account Module (206) to serve as reference for a future show.

Finally, it has to be appreciated that while the invention has been particularly shown and described with reference to a preferred embodiment, various changes in form and detail may be made therein without departing from the spirit, and scope of the invention.

1. A system for monitoring a computer implemented presentation in accordance to an audience reaction, comprising:
storing means for storing a set of predefined audience behavior parameters to define a reference audience behavior;
sensing means for sensing biometrics information indicative of an ongoing audience behavior;
means for processing the sensed biometrics information to detect an audience behavior deviation compared to the reference audience behavior; and
means for generating one or more presentation adjustments parameters in case of deviation.

2. The system of claim 1, wherein the sensing means comprises means for sensing acoustic biometrics information and visual biometrics information.

3. The system of claim 2, wherein the acoustic biometrics information includes voice recognition and wherein the visual biometrics information includes image recognition.

4. The system of claim 1, wherein the processing means further comprises:
means for classifying the sensed biometrics information into ongoing audience behavior parameters.

5. The system of claim 4, further comprising:
means for comparing the ongoing audience behavior parameters to the set of predefined audience behavior parameters.

6. The system of claim 5, wherein the processing means further comprises:
means for computing a deviation probability between the ongoing audience behavior parameters and the set of predefined audience behavior parameters.

7. The system of claim 1, further comprising:
means for updating the ongoing presentation with the one or more presentation adjustments parameters.

8. The system of claim 1, further comprising:
means for allowing a user to defined a set of user presentation preferences.

9. The system of claims 1, wherein the storing means further comprises:
means for storing a plurality of predefined presentations.

10. The system of claim 1, wherein the one or more presentation adjustments parameters comprise at least one of color adjustment, volume adjustment and slide deletion.

11. A method for monitoring a computer implemented presentation in accordance to an audience reaction, comprising:
storing a set of predefined audience behavior parameters to define a reference audience behavior;
receiving biometrics information indicative of an ongoing audience behavior;
processing the biometrics information to detect an audience behavior deviation compared to the reference audience behavior; and
generating one or more presentation adjustments parameters in case of deviation.

12. The method of claim 11, wherein the receiving comprises sensing acoustic biometrics information and visual biometrics information.

13. The method of claim 12, wherein the acoustic biometrics information includes voice recognition and wherein the visual biometrics information includes image recognition.

14. The method of claim 11, wherein the processing further comprises:
classifying the sensed biometrics information into ongoing audience behavior parameters.

15. The method of claim 14, further comprising:
comparing the ongoing audience behavior parameters to the set of predefined audience behavior parameters.

16. The method of claim 15, wherein the processing further comprises:
computing a deviation probability between the ongoing audience behavior parameters and the set of predefined audience behavior parameters.

17. The method of claim 11, further comprising:
updating the ongoing presentation with the one or more presentation adjustments parameters.

18. The method of claim 11, further comprising:
allowing a user to defined a set of user presentation preferences.

19. The method of claims 11, wherein the storing further comprises:
storing a plurality of predefined presentations.

20. The method of claim 11, wherein the one or more presentation adjustments parameters comprise at least one of color adjustment, volume adjustment and slide deletion.
